(19) United States
(12) Patent Application Publication
(10) Pub. No.: US 2021/0342632 A1
(43) Pub. Date: Nov. 4, 2021

(54) IMAGE PROCESSING METHOD AND APPARATUS, ELECTRONIC DEVICE, AND STORAGE MEDIUM

(71) Applicant: SHANGHAI SENSETIME INTELLIGENT TECHNOLOGY CO., LTD., Shanghai (CN)

(72) Inventors: Jiafei WU, Shanghai (CN); Mingliang LIANG, Shanghai (CN)

(73) Assignee: SHANGHAI SENSETIME INTELLIGENT TECHNOLOGY CO., LTD., Shanghai (CN)

(21) Appl. No.: 17/378,931

(22) Filed: Jul. 19, 2021

Related U.S. Application Data
(63) Continuation of application No. PCT/CN2019/114465, filed on Oct. 30, 2019.

(30) Foreign Application Priority Data
Mar. 25, 2019 (CN) 201910228716.X

(51) Int. Cl. G06K 9/62; G06K 9/03

(52) U.S. Cl. CPC G06K 9/629; G06K 9/6289; G06K 9/03; G06K 9/623

(57) ABSTRACT

An image processing method includes: obtaining an image feature of each of a plurality of images for a same object; determining, according to the image feature of each of the plurality of images, a weight coefficient having a one-to-one correspondence with each image feature; and performing feature fusion processing on the image features of the plurality of images based on the weight coefficient of each image feature to obtain a fusion feature of the plurality of images.

### CROSS-REFERENCE TO RELATED APPLICATIONS

This application is a continuation of International Application No. PCT/CN2019/114465 filed on Oct. 30, 2019, which claims priority to Chinese Patent Application No. 201910228716.X filed on Mar. 25, 2019. The disclosures of these applications are hereby incorporated by reference in their entirety.

### BACKGROUND

Feature fusion is one of important issues in computer vision and intelligent video monitoring. For example, application of fusion of face features is important in many fields such as a face recognition system. At present, usually an average of features of multiple frames of images is directly used as a feature obtained as a result of the fusion. This method is simple but has a poor performance, especially poor robustness for an abnormal value.

### SUMMARY

The disclosure relates to the field of computer vision technology and particularly to, an image processing method and device, an electronic device and a storage medium.

An image processing method and device, an electronic device and a storage medium are provided in the embodiments of the disclosure.

A first aspect according to the embodiments of the disclosure provides an image processing method, the method including: obtaining an image feature of each of multiple images for a same object; determining, according to the image feature of each of the multiple images, a weight coefficient having a one-to-one correspondence with each image feature; and performing feature fusion processing on the image features of the multiple images based on the weight coefficient of each image feature to obtain a fusion feature of the multiple images.

A second aspect according to the embodiments of the disclosure provides an image processing device, the device including: a memory storing processor-executable instructions; and a processor configured to execute the stored processor-executable instructions to perform operations of: obtaining an image feature of each of a plurality of images for a same object; determining, according to the image feature of each of the plurality of images, a weight coefficient having a one-to-one correspondence with each image feature; and performing feature fusion processing on the image features of the plurality of images based on the weight coefficient of each image feature to obtain a fusion feature of the plurality of images.

A third aspect according to the embodiments of the disclosure provides a non-transitory computer-readable storage medium having stored thereon computer-readable instructions that, when executed by a processor, cause the processor to perform an image processing method, the method including: obtaining an image feature of each of a plurality of images for a same object; determining, according to the image feature of each of the plurality of images, a weight coefficient having a one-to-one correspondence with each image feature; and performing feature fusion processing on the image features of the plurality of images based on the weight coefficient of each image feature to obtain a fusion feature of the plurality of images.

It is to be understood that the above general descriptions and detailed descriptions below are only exemplary and explanatory and not intended to limit the present disclosure.

Other features and aspects of the disclosure will be made clear by detailed descriptions of exemplary embodiments with reference to accompanying drawings below.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of an image processing method according to an embodiment of the disclosure.

FIG. 2 is a flowchart of determination of a manner of obtaining weight coefficients in an image processing method according to an embodiment of the disclosure.

FIG. 3 is a flowchart of operation S20 in an image processing method according to an embodiment of the disclosure.

FIG. 4 is a flowchart of performing first optimizing processing in an image processing method according to an embodiment of the disclosure.

FIG. 5 is a flowchart of operation S232 in an image processing method according to an embodiment of the disclosure.

FIG. 6 is a flowchart of operation S20 in an image processing method according to an embodiment of the disclosure.

FIG. 7 is a flowchart of operation S203 in an image processing method according to an embodiment of the disclosure.

FIG. 8 is a block diagram of an image processing device according to an embodiment of the disclosure.

FIG. 9 is a block diagram of an electronic device 800 according to an embodiment of the disclosure.

FIG. 10 is a block diagram of an electronic device 1900 according to an embodiment of the disclosure.

### DETAILED DESCRIPTION

Various exemplary embodiments, features and aspects of the present disclosure are described in detail below with reference to the accompanying drawings. Elements with same functions or similar elements are represented by a same reference sign in an accompanying drawing. Although each aspect of the embodiments is illustrated in the accompanying drawing, the drawings do not have to be plotted to scale unless specifically indicated.

Herein the specific word “exemplary” means “used as an example or an embodiment, or descriptive”. Herein it is not necessary to explain that any embodiment described as “exemplary” is superior to or better than other embodiments.

The term “and/or” in the disclosure only represents an association relationship for describing associated objects, and may represent three relationships. For example, A and/or B may represent three conditions: i.e., only A, both A and B, and only B. In addition, herein the term “at least one” represents “any one of many” or “any combination of at least two of many”. For example, “including at least one of A, B or C” may represent that “selecting one or more elements from among a set composed of A, B and C”.

In addition, a great many details are given in the following detailed description to make the disclosure better described. Those skilled in the art should understand the embodiments of the disclosure are also able to be implemented in the absence of some details. In some examples, methods, means, elements and electric circuits familiar to those skilled in the art are not described in detail to make the main idea of the embodiments of the disclosure shown clearly.

An image processing method that may perform feature fusion processing on multiple images is provided in the embodiments of the disclosure. The method may be applied to any electronic device or server. For example, the electronic device may include User Equipment (UE), a mobile device, a cellular phone, a cordless phone, a Personal Digital Assistant (PDA), a hand-held device, a computing device, a vehicle-mounted device, a wearable device or the like. The server may include a local server or a cloud server. In some embodiments, a processor may execute computer-readable instructions stored in a memory to perform the image processing method. The above is merely exemplary description of the devices and does not serve as detailed limitation on the disclosure. In the other embodiments, the method may be implemented through other devices that are able to perform the image processing.

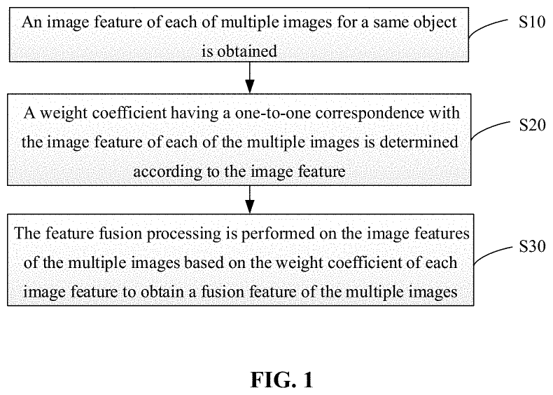

FIG. 1 is a flowchart of an image processing method according to an embodiment of the disclosure. The image processing method includes operations S10 to S30.

In operation S10, an image feature of each of multiple images for a same object is obtained.

In some embodiments, feature fusion processing may be performed on features of different images for a same object. The object may belong to any type. For example, the object may be a person, an animal, a plant, a vehicle, a cartoon character or the like. The embodiment of the disclosure is not limited thereto. The different images for the same object may be ones captured in a same scenario or ones captured in different scenarios. When the images are obtained is also not limited in embodiments of the disclosure. These images may be obtained at the same time or at different times.

In some embodiments, the multiple images for the same object may be obtained at first. Manners for obtaining the multiple images may include: acquiring multiple images through a camera device, receiving multiple images from another device through communication with the device, reading multiple images stored locally or stored at a particular network address. These listed manners are only some examples. The multiple images for the same objects may be obtained in other manners in other embodiments.

After the multiple images are obtained, image features in the multiple images may be extracted respectively. In some embodiments, the images features may be extracted based on a feature-extracting algorithm such as a face feature extracting algorithm, an edge feature extracting algorithm. Alternatively, features related to the object may be extracted based on other feature-extracting algorithms. Alternatively, in some embodiments, the image feature in each of the multiple images may be extracted through a neural network with a feature-extracting function. An image feature of an image may reflect feature information of the image or feature information of an object in the image. For example, the image feature may be a gray scale value of each pixel in the image.

In some embodiment of the disclosures, when the object included in the image is a human object, the obtained image feature may be a face feature of the object. For example, each image may be processed based on a face feature extracting algorithm to extract the face feature from the image. Alternatively, each image may also be inputted into a neural network that is able to obtain the face feature in an image so that the face feature of the image can be obtained through the neural network. The neural network may be one that is able to obtain the image features of the images and perform recognition on the object in the images after it has undergone a training. In this way, a result of processing the images through a last convolutional layer of the neural network may be taken as the image features in some embodiments (the obtained features are ones that the images have prior to classification and recognition). The neural network may be a convolutional neural network. Alternatively, when the object is of another type other than a human object, the image features corresponding to the object may be obtained through a corresponding feature-extracting algorithm or a corresponding neural network. The embodiment of the disclosure is not limited thereto.

In some embodiments, the image feature may be in a form of a feature vector. For example, an image feature of an i-th image (such as a face feature) may be expressed as: Xᵢ=[xᵢ₁, xᵢ₂, xᵢ₃, . . . , x_{iD}], where D represents a number of dimensions of the image feature, i is an integer between 1 and N and N represents a number of the images.

In operation S20, a weight coefficient having a one-to-one correspondence with the image feature of each of the multiple images is determined according to the image feature.

In some embodiments, the weight coefficient of the image feature of each image may be determined according to feature parameters in the image feature of the image. The weight coefficient may be in or out of an interval [0, 1]. The embodiment of the disclosure is not limited thereto. Image features with a high precision may be highlighted by configuring different weight coefficients for all the image features so that a precision of fusion feature that is obtained as a result of the feature fusion processing may be increased.

In operation S30, the feature fusion processing is performed on the image features of the multiple images based on the weight coefficient of each image feature to obtain the fusion feature of the multiple images.

In some embodiments, a manner of performing the feature fusion processing may include: the fusion feature is obtained by summing products of the image features and corresponding weight coefficients. For example, the fusion feature of the image features may be obtained through a following expression:

$$G = {\sum }_{i = 1}^{N} {b}_{i} {X}_{i} . \qquad ( 1 )$$

In the expression, G represents the generated fusion feature, i is an integer between 1 and N, N represents a number of the multiple images, b represents a weight coefficient of the image feature X, of the i-th image.

In other words, in some embodiments, the fusion feature may be obtained by multiplying each image feature and the weight coefficient corresponding to the image feature and adding the results of the multiplications together.

In some embodiments, the fusion feature is not obtained by simply averaging all the image features directly but obtained according to the weight coefficient corresponding to each image feature that is determined according to the feature parameters in the image feature. In this way, the solution in some embodiments increases the precision of the fusion feature and is easy to implement.

Each process in some embodiments is described in detail below in combination with the accompanying drawings.

In some embodiments, after the image features of the different images for the same object are obtained, the weight coefficient of each image feature may be determined. In some embodiments, each weight coefficient may be obtained through a feature fitting manner. In some other possible implementations, each weight coefficient may be obtained through a median filtering manner. In other implementations, alternatively, each weight coefficient may be obtained by performing averaging or other processing. The embodiment of the disclosure is not limited thereto.

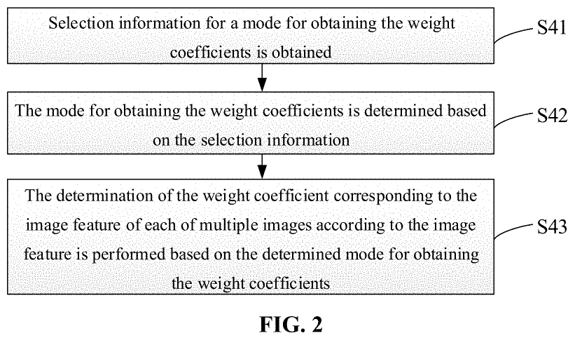

In some embodiments, before operation S20 is performed to obtain each weight coefficient, a manner of obtaining each weight coefficient such as the feature fitting manner, median filtering manner may be determined at first. FIG. 2 is a flowchart of determination of a manner of obtaining weight coefficients in an image processing method according to an embodiment of the disclosure. The method further includes operations S41 to S43 that are performed before the operation that the weight coefficient corresponding to the image feature of each of the multiple images is determined according to the image feature.

In operation S41, selection information for a mode for obtaining the weight coefficients is obtained.

The selection information is mode selection information that is related to performing the operation of obtaining the weight coefficients. For example, the selection information may be first selection information for obtaining the weight coefficients using a first mode (such as the feature fitting manner) or second selection information for obtaining the weight coefficients using a second mode (such as the median filtering manner). Alternatively, the selection information may also include selection information for obtaining the weight coefficients using other modes. The embodiment of the disclosure is not limited thereto.

A manner of obtaining the selection information may be: receiving input information received by an input component and determining the selection information based on the input information. In some embodiments, the input component may include a switch, a keyboard, a mouse, an audio reception interface, a touch pad, a touch screen, a communication interface or the like. The embodiment of the disclosure is not limited thereto. Any device that is able to receive the selection information may be used in some embodiments.

In operation S42, the mode for obtaining the weight coefficients is determined based on the selection information.

Since the selection information includes information related to the mode for obtaining the weight coefficient, corresponding mode information may be obtained according to the received selection information. Under condition that the selection information includes the first selection information, the first mode (the feature fitting manner) may be adopted to obtain the weight coefficients; under condition that the selection information includes the second selection information, the second mode (the median filtering manner) may be adopted to obtain the weight coefficients. Accordingly, in response to that the selection information includes other selection information, a mode for obtaining the weight coefficients that corresponds to the selection information may be determined.

In some embodiments, at least one of precision, computation burden, or computation speed for one of the modes for obtaining the weight coefficients may be different from other modes. For example, compared with the second mode, the first mode has a greater precision but the computations involved in the first mode are slower. However, the embodiment of the disclosure is not limited thereto. Therefore, in some embodiments, a user may choose a suitable mode to obtain the weight parameters according to different requirements.

In operation S43, the determination of the weight coefficient corresponding to the image feature of each of multiple images according to the image feature is performed based on the determined mode for obtaining the weight coefficients. The modes for obtaining the weight coefficients include obtaining the weight coefficients in the feature fitting manner and obtaining the weight coefficients in the median filtering manner.

After the mode for obtaining the weight coefficients is determined based on the selection information, the weight information may be obtained according to the determined mode.

In some embodiments, the above operations may make it possible to select the mode for obtaining the weight coefficients. Under different requirements, different modes may be adopted to obtain the weight coefficients, thus, the technical solution according to the embodiment is more applicable.

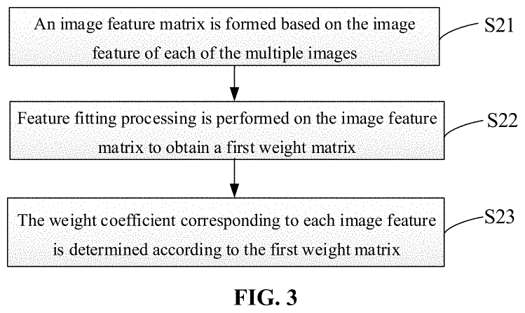

The manner of obtaining the weight coefficients in some embodiments is described in detail below. FIG. 3 is a flowchart of operation S20 in an image processing method according to an embodiment of the disclosure. The operation that the weight coefficient corresponding to the image feature of each of the multiple images is determined according to the image feature (operation S20) may include operations S21 to S23.

In operation S21, an image feature matrix is formed based on the image feature of each of the multiple images.

In some embodiments, the image feature of each of the multiple images may be in a form of a feature vector. For example, the image feature of the i-th image may be expressed as Xᵢ=[xᵢ₁, xᵢ₂, xᵢ₃, . . . , x_{iD}], where D represents the number of dimensions of the image feature, i is an integer between 1 and N, and N represents the number of the multiple images. In some embodiments, the image features of all the images have a same number of dimensions, which is equal to D.

The image feature matrix X that is formed according to the image feature of each image may be expressed as:

$$X = [ {X}_{1} , {X}_{2} , … , {X}_{N} ] = \{ \begin{matrix}{x}_{11} & {x}_{12} & … & {x}_{1 D} \\ {x}_{21} & {x}_{22} & … & {x}_{2 D} \\ . & . & . & . \\ {x}_{N 1} & {x}_{N 2} & … & {x}_{ND}\end{matrix} \} . \qquad ( 2 )$$

The image feature matrix constituted by all the image features may be obtained based on the expression (2). In the above manner, elements in each row of the image feature matrix may be determined as an image feature of an image and different rows correspond to the image features of different images. In other implementations, elements in each column of the image feature matrix may also be determined as an image feature of an image, and different columns correspond to the image features of different images. Arrangement of the elements in the image feature matrix is not limited in embodiments of the disclosure.

In operation S22, feature fitting processing is performed on the image feature matrix to obtain a first weight matrix.

After the image feature matrix corresponding to each image feature is obtained, the feature fitting processing may be performed on the image feature matrix. In some embodiments, a regularized least-square linear regression algorithm may be adopted to perform the feature fitting processing. For example, a preset target function that is a function related to the weight coefficients may be prepared. Under condition that the preset target function takes its minimum value, the first weight matrix corresponding to each weight coefficient is determined. The first weight matrix has a same number of dimensions as the image feature. The final weight coefficients may be determined according to each element in the first weight matrix.

In some embodiments, an expression of the preset target function may be:

$${min}_{b} {‖ {X}^{T} b - Y ‖}_{2}^{2} + λ {‖ b ‖}_{2}^{2} . \qquad ( 3 )$$

In the expression (3), X represents the image feature matrix, b=[b₁, b₂, . . . , b_{N}]^{T} represents the first weight matrix to be estimated, Y represents an observation matrix that is identical to X, X^{T} represents a transpose of X, λ represents a regularized parameter, and ∥ μ₂² represents an L2-norm regularized term of the parameter.

In some embodiments, if the image feature is a row vector, the generated first weight matrix is a column vector; if the image feature is a column vector, the generated first weight matrix is a row vector. In addition, the number of dimensions in the first weight matrix is equal to the number of the image features or the number of the multiple images.

In some embodiments, under condition that the target function takes its minimum value, a value of the first weight matrix b and a final first weight matrix may be obtained. The first weight matrix may have an expression:

b=(X^{T}X+λI)⁻¹X^{T}Y (4).

The above embodiment makes it possible to obtain the first weight matrix by performing the feature fitting processing. In other implementations of the disclosure, the first weight matrix may also be obtained by adopting other feature fitting manners to perform the feature fitting processing on the image feature matrix or preparing different preset target functions to perform the feature fitting processing on the image feature matrix. The embodiment of the disclosure is not limited thereto.

In operation S23, the weight coefficient corresponding to each image feature is determined according to the first weight matrix.

After the first weight matrix is obtained, the weight coefficients corresponding to respective image features may be determined according to the obtained first weight matrix.

In some embodiments, each element included in the first weight matrix may be taken as a weight coefficient, that is to say, each of first weight coefficients included in the first weight matrix may be taken as a weight coefficient corresponding to an image feature. Under condition that the obtained first weight matrix is b=[b₁, b₂, . . . , b_{N}]^{T}, the weight coefficient of the image feature Xᵢ of the i-th image may be bᵢ.

In some other implementations of the disclosure, in order to further increase a precision of the weight coefficients, optimizing processing may also be performed on the first weight matrix to obtain an optimized first weight matrix and elements in the optimized first weight matrix may be taken as the weight coefficients of all the image features. In other words, first optimizing processing may be performed on the first weight matrix and each of the first weight coefficients included in the optimized first weight matrix is determined as a weight coefficient corresponding to an image feature. The first optimizing processing makes it possible to make abnormal values in the first weight matrix detected so that corresponding optimizing processing may be performed on the abnormal values to increase a precision of the obtained weight matrix.

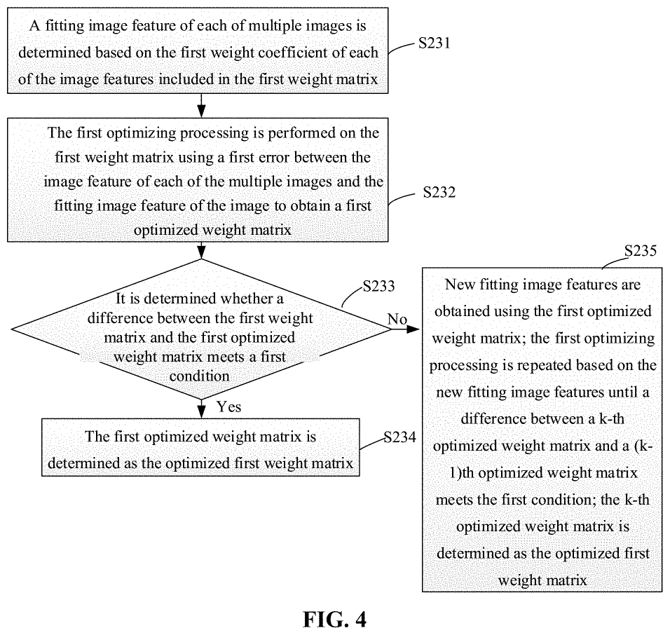

FIG. 4 is a flowchart of performing first optimizing processing in an image processing method according to an embodiment of the disclosure. The operation that the first optimizing processing is performed on the first weight matrix and each of the first weight coefficients included in the optimized first weight matrix is determined as the weight coefficient corresponding to an image feature may include operations S231 to S235.

In operation S231, a fitting image feature of each of multiple images is determined based on the first weight coefficient of each of the image features included in the first weight matrix. The fitting image feature is a product of the image feature and the first weight coefficient corresponding to the image feature.

In some embodiments, the fitting image feature corresponding to each image feature may be obtained based on the determined first weight matrix at first. The fitting image feature corresponding to each of the image features included in the first weight matrix may be obtained by multiplying the first weight coefficient of the image feature by the image feature. For example, the first weight coefficient bᵢ of the image feature Xᵢ of the i-th image in the first weight matrix may be multiplied by the image feature Xᵢ to obtain the fitting image feature bᵢXᵢ.

In operation S232, the first optimizing processing is performed on the first weight matrix using a first error between the image feature of each of the multiple images and the fitting image feature of the image to obtain a first optimized weight matrix.

After the fitting image features are obtained, the first error between an image feature and a fitting image feature corresponding to the image feature may be obtained. In some embodiments, the first error between the image feature and the fitting image feature may be obtained according to a following expression:

$${e}_{i} = {\sum }_{j = 1}^{D} {( {\sum }_{i = 1}^{N} {b}_{i} {X}_{i} - {X}_{i} )}^{2} . \qquad ( 5 )$$

Herein, eᵢ represents a first error between the i-th image feature and a fitting image feature corresponding to the i-th image feature, i is an integer between i and N, N is the number of the image features, j is an integer between 1 and D, D represents the number of the dimensions of each image feature, X, represents the image feature of the i-th image and bᵢXᵢ represents the fitting image feature corresponding to the i-th image feature.

In other implementations of the disclosure, the first error between the image feature and the fitting image feature may be determined in other manners. For example, an average of differences between elements in the fitting image feature and corresponding elements in the image feature may be directly determined as the first error. The manner of determining the first error is not limited in embodiments of the disclosure.

After the first error is obtained, the first error may be adopted to perform the optimizing processing on the first weight matrix for the first time to obtain the first optimized weight matrix. Elements in the first optimized weight matrix may also represent the weight coefficients corresponding to all the image features that have been optimized for the first time.

In operation S233, it is determined whether a difference between the first weight matrix and the first optimized weight matrix meets a first condition. If the first condition is met, operation S234 is to be performed; otherwise, operation S235 is to be performed.

After a first optimizing processing result of the first weight matrix (the first optimized weight matrix) is obtained based on the first errors, it can be determined whether the difference between the first optimized weight matrix and the first weight matrix meets the first condition. If the difference meets the first condition, the first optimized weight matrix does not have to be optimized further and can be determined as an optimized weight matrix that is obtained after the first optimized processing is performed for a last time. If the difference between the first optimized weight matrix and the first weight matrix does not meet the first condition, the first optimized weight matrix has to be subjected to the optimizing processing again.

In some embodiments, the first condition may be that an absolute value of the difference between the first optimized weight matrix and the first weight matrix is less than a first threshold. The first threshold is a threshold set in advance and may be a value less than 1 such as 0.01. In some embodiments, the first threshold may be set on demand and is not limited in embodiments of disclosure.

Based on the above embodiment, whether the difference between the first optimized weight matrix and the first weight matrix meets the first condition can be determined to further perform corresponding subsequent operations.

In operation S234, the first optimized weight matrix is determined as the optimized first weight matrix.

According to the descriptions in the above embodiment, if it is determined that the difference between the first optimized weight matrix and the first weight matrix meets the first condition, the first optimized weight matrix does not have to be subjected to the optimized processing again and can be directly determined as an optimized weight matrix obtained after the first optimizing processing is performed for the last time.

In operation S235, new fitting image features are obtained using the first optimized weight matrix; the first optimizing processing is repeated based on the new fitting image features until a difference between a k-th optimized weight matrix and a (k−1)th optimized weight matrix meets the first condition; the k-th optimized weight matrix is determined as the optimized first weight matrix, herein k is a positive integer greater than 1.

In some embodiments, it is possible that the difference between the first optimized weight matrix, which is obtained by performing the first optimizing processing on the image features based on the first errors between the image features and the fitting image features, and the first weight matrix does not meet the first condition. If the difference does not meet the first condition (for example, the difference is greater than the first threshold), the weight coefficients in the first optimized weight matrix may be further adopted to obtain the fitting image feature corresponding to each image feature and then the first error between the image feature and the fitting image feature is adopted to perform the first optimizing processing for the second time to obtain a second optimized weight matrix.

If a difference between the second optimized weight matrix and the first optimized weight matrix meets the first condition, the second optimized weight matrix may be determined as a final optimization result, namely a weight matrix that is obtained after the optimizing processing. If the difference between the second optimized weight matrix and the first optimized weight matrix still does not meet the first condition, weight coefficients in the second optimized weight matrix may be further adopted to obtain the fitting image feature corresponding to each image feature and the first optimizing processing is performed for the third time according to the first error between the image feature and the fitting image feature to obtain a third optimized weight matrix. The above operations are repeated until the difference between the k-th optimized weight matrix and the (k−1)th optimized weight matrix meets the first condition. After that, the k-th optimized weight matrix may be determined as the optimized first weight matrix, where k is an integer greater than 1.

The above embodiment makes it possible to perform the first optimizing processing and obtain the optimized first weight matrix according to the first errors between the image features and the fitting image features. In some embodiments, an expression of an iterative function of the first optimizing processing may be

b^{(t)}=(X^{T}W^{(t-1)}X+λI)⁻¹X^{T}W^{(t-1)}Y (6).

In the expression (6), t represents a number of iterations (a number of times the first optimizing processing is performed), b^{(t)} represents the first optimized weight matrix that is obtained after the first optimized processing is performed for the t-th time, X represents the image feature matrix, Y represents the observation matrix that is same as X, W^{(t-1)} represents a diagonal matrix of the second weight coefficients wᵢ that is obtained during a (t−1)th iteration, I is a diagonal matrix, and λ represents a regularized parameter. As can be seen from the above embodiment, in some embodiments, the first optimizing processing may be performed on the weight matrix each time by adjusting the second weight coefficients wᵢ.

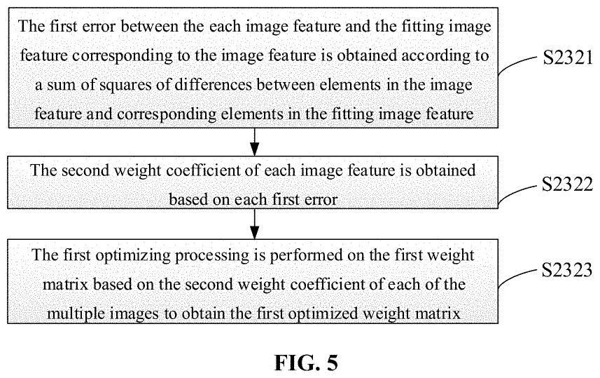

The first optimizing processing is described in some embodiments in combination with the first optimizing processing performed on the first weight matrix for the first time. FIG. 5 is a flowchart of operation S232 in an image processing method according to an embodiment of the disclosure. The operation that the first optimizing processing is performed on the first weight matrix using the first error between the image feature of each of the multiple images and the fitting image feature of the image includes operation S2321 to S2323.

In operation S2321, the first error between the each image feature and the fitting image feature corresponding to the image feature is obtained according to a sum of squares of differences between elements in the image feature and corresponding elements in the fitting image feature.

According to the description in the above embodiment, after each image feature and the fitting image feature corresponding to the image feature is obtained, the first error between the image feature and the fitting image feature corresponding to the image feature may be determined. The preceding expression (5) may be referred to for the determination of the first error.

In operation S2322, the second weight coefficient of each image feature is obtained based on each first error.

After the first error between each image feature and the fitting image feature corresponding to the image feature is determined, the second weight coefficient of the image feature may be determined according to a value of the first error. The second weight coefficient is used for performing the first optimizing processing. The second weight coefficient of the image feature may be determined in a first manner. An expression of the first manner may be:

$${w}_{i} = \{ \begin{matrix}1 , {e}_{i} \leq k \\ \frac{k}{\vert {e}_{i} \vert} , {e}_{i} > k\end{matrix} . \qquad ( 7 )$$

In the expression, wᵢ represents a second weight coefficient of the i-th image, eᵢ represents the first error between an i-th image feature and a fitting image feature corresponding to the i-th image feature, i is an integer between 1 and N, N represents the number of the image features, k=1.345 σ, and σ is a standard deviation of the errors eᵢ. In some embodiments, k may represent a threshold for the errors and it may be 1.345 times as great as the standard deviation of the first errors between all the image features and all the fitting image features. In other implementations, k may be equal to another value such as 0.6 and does not serve as a detailed limitation on the embodiment of the disclosure.

After the first error between each image feature and the fitting image feature corresponding to the image feature is obtained, the first error may be compared with threshold k for the errors. If the first error is less than k, the second weight coefficient corresponding to the image feature may be set to be a first value such as 1. If the first error is greater than or equal to k, the second weight coefficient of the image feature may be determined according to the first error; in this way, the second weight coefficient may be a second value

$$\frac{k}{\vert {e}_{i} \vert}$$

that is a ratio of k to an absolute value of the first error.

In operation S2323, the first optimizing processing is performed on the first weight matrix based on the second weight coefficient of each of the multiple images to obtain the first optimized weight matrix.

After the second weight coefficients of the image features are obtained, the first optimizing processing may be performed on the first weight matrix using the second weight coefficients. The first optimized weight matrix may be obtained using the iterative function b^{(t)}=(X^{T}W^{(t-1)}X+λI)⁻¹X^{T}W^{(t-1)}Y.

In some embodiments, if the difference between the first optimized weight matrix and the first weight matrix does not meet the first condition, after the new fitting image features are obtained using the weight coefficients in the first weight matrix, a second weight coefficient of each image feature may be determined again according to a first error between the image feature and the new fitting image feature corresponding to the image feature. In this way, the above function is iterated according to the newly determined second weight coefficients to obtain the second optimized weight matrix. According to the above operations, the k-th optimized weight matrix corresponding to the first optimizing processing that is performed for the k-th time may be obtained.

Therefore, it can be further determined whether a difference between the k-th optimized weight matrix obtained after the first optimizing processing is performed for the k-th time and the (k−1)th optimized weight matrix obtained after the first optimizing processing is performed for the (k−1)th time meets the first condition, where ϵ is the first threshold. If the difference meets first condition, the k-th optimized weight matrix b^{(t)} may be determined as the optimized first weight matrix.

The above embodiment makes it possible to obtain the weight coefficients of the image features in the feature fitting manner. The weight coefficients obtained in the manner have a high precision. In addition, the manner brings better robustness for the normal values in the weight coefficients.

According to the above description, a method for determining the weight coefficient of each image feature in the median filtering manner is further provided in some embodiments. Compared with the feature fitting manner, this method entails fewer computations.

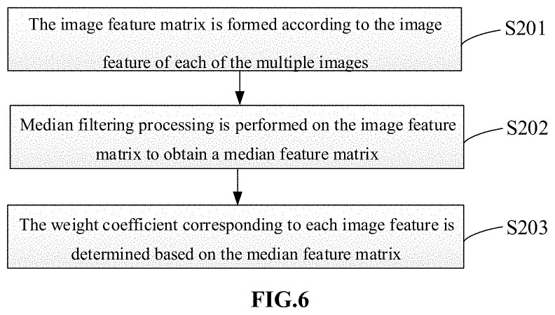

FIG. 6 is a flowchart of operation S20 in an image processing method according to an embodiment of the disclosure. The operation (operation S20) that the weight coefficient corresponding to the image feature of each of the multiple images is determined according to the image feature.

In operation S201, the image feature matrix is formed according to the image feature of each of the multiple images.

The image feature matrix is formed according to the image feature of each of the multiple images in some embodiments, which is identical to operation S21. The image feature may be expressed in a form of a feature vector. For example, the image feature of the i-th image may be expressed as Xᵢ=[xᵢ₁, xᵢ₂, xᵢ₃, . . . , x_{iD}], where D represents the number of dimensions of the image feature, i is an integer between i and N and N represents the number of the images. In some embodiments, the image features of all the images have a same number of dimensions, which is equal to D.

The image feature matrix X that is formed according to the image feature of each of the multiple images may be expressed as the above expression (2):

$$X = [ {X}_{1} , {X}_{2} , … , {X}_{N} ] = \{ \begin{matrix}{x}_{11} & {x}_{12} & … & {x}_{1 D} \\ {x}_{21} & {x}_{22} & … & {x}_{2 D} \\ . & . & . & . \\ {x}_{N 1} & {x}_{N 2} & … & {x}_{ND}\end{matrix} \} . \qquad ( 2 )$$

The above operation makes it possible to obtain the image feature matrix constituted by all the image features. In the above manner, elements in each row of the image feature matrix may be determined as an image feature of an image and different rows correspond to the image features of different images. In other implementations, elements in each column of the image feature matrix may also be determined as an image feature of an image and different columns correspond to the image features of different images. Arrangement of the elements in the image feature matrix is not limited in embodiments of the disclosure.

In operation S202, median filtering processing is performed on the image feature matrix to obtain a median feature matrix.

In some embodiments, after the image feature matrix is obtained, the median filtering processing may be performed on the obtained image feature matrix to obtain the median feature matrix corresponding to the image feature matrix. Any element in the median feature matrix is a median of the image features corresponding to elements in the image feature matrix.

In some embodiments, an element median of element values at a same position for each image feature in the image feature matrix may be determined; the median feature matrix is obtained based on the element median at each position.

For example, the image feature matrix in some embodiments is expressed as the expression (2):

$$X = [ {X}_{1} , {X}_{2} , … , {X}_{N} ] = \{ \begin{matrix}{x}_{11} & {x}_{12} & … & {x}_{1 D} \\ {x}_{21} & {x}_{22} & … & {x}_{2 D} \\ . & . & . & . \\ {x}_{N 1} & {x}_{N 2} & … & {x}_{N D}\end{matrix} \} ,$$

and the median of the element values at each same position for each image feature may be obtained. Herein, “position” is a position corresponding to a sequence number of each image feature. For example, first elements of all the image features may be (x₁₁, x₂₁, . . . , x_{N1}), or j-th elements at a position j for each image feature may be (x₁ⱼ, x₂ⱼ, . . . , x_{Nj}). Thus, elements at a same position may be determined. In some embodiments, the obtained median feature matrix may have a same number of dimensions as the image feature. The median feature matrix may be expressed as M=[m₁, m₂, . . . , m_{D}] and a j-th element of the median feature matrix may be mⱼ=median([m₁ⱼ, m₂ⱼ, . . . , m_{Nj}]), where j is an integer between 1 and D and median is a median function. Thus, it is possible to obtain a feature value at a middle position among all feature values for [m₁ⱼ, m₂ⱼ, . . . , m_{Nj}]. Firstly, elements in [m₁ⱼ, m₂ⱼ, . . . , m_{Nj}] may be sorted in a descending order. When N is an odd number, the obtained median is an image feature value (element value) at the middle position (of the ((N+1)/2)th element); when N is an even number, the obtained median is an average of two element values of the middle elements.

The median feature matrix corresponding to each of the image features in the image feature matrix may be obtained based on the above operations.

In operation S203, the weight coefficient corresponding to each image feature is determined based on the median feature matrix.

After the median feature matrix corresponding to each image feature is obtained, the weight coefficient of the image feature may be obtained using the median.

In some embodiments, the weight coefficient of each image feature may be determined according to a second error between the image feature and the median feature matrix.

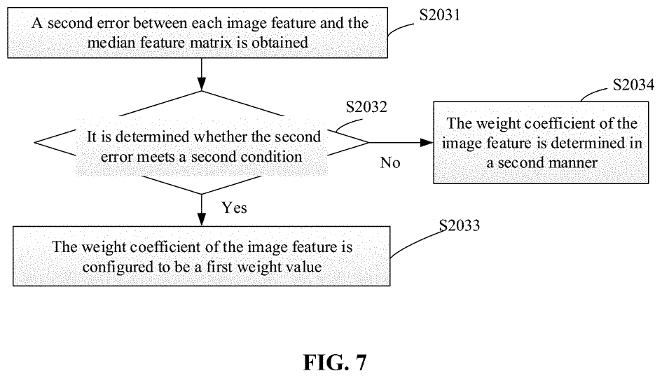

FIG. 7 is a flowchart of operation S203 in an image processing method according to an embodiment of the disclosure. The operation that the weight coefficient corresponding to each image feature is determined based on the median feature matrix includes operations S2031 to S2034.

In operation S2031, the second error between each image feature and the median feature matrix is obtained.

In some embodiments, a sum of absolute values of differences between elements in the image feature and corresponding elements in the median feature matrix may be determined as the second error between the image feature and the median feature matrix. An expression of the second error may be:

$${e}_{h} = {\sum }_{h = 1}^{D} \vert M - {X}_{h} \vert . \qquad ( 8 )$$

In the expression (8), eₕ is a second error between an image feature Xₕ of an h-th image and the median feature matrix, M represents the median feature matrix, Xₕ represents the image feature of the h-th image and h is an integer between 1 and N.

The above embodiment makes it possible to obtain the second error between each image feature and the median feature matrix and further determine the weight coefficient corresponding to the image feature according to the second error.

In operation S2032, it is determined whether the second error meets a second condition; if the second error meets the second condition, operation S2033 is to be performed; otherwise operation S2034 is to be performed.

The second condition in some embodiments may be that the second error is greater than a second threshold. The second threshold may be a preset value or a value that is determined according to the second error between each image feature and the median feature matrix. The embodiment of the disclosure is not limited thereto. In some embodiments, expressions of the second condition may be:

eₕ>K·MADN (9); and

MADN=median([e₁, e₂, . . . , e_{N}])/0.675 (10).

In the above two expressions, eₕ is a second error between the image feature of the h-th image and the median feature matrix, h is an integer between 1 and N, N represents the number of the images, K is a determination threshold that may be a preset value such as 0.8 and does not serve as a limitation on the embodiment of the disclosure, and median is the median filtering function. In some embodiments, the second threshold may be a product of a ratio of an average of the second errors corresponding to all the image features to 0.675 and the determination threshold K. The determination threshold K may be a positive number that is greater than 1.

After the second condition or the second threshold is set, it can be determined whether the second error between the image feature and the median feature matrix meets the second condition so as to perform subsequent operations according to a determination result.

In operation S2033, the weight coefficient of the image feature is configured to be a first weight value.

In some embodiments, in response to that a second error between an image feature and the median feature matrix meets the second condition (for example, the second error is greater than the second threshold), it is possible that the image feature is abnormal and the first weight value is determined as a weight coefficient of the image feature. The first weight value in some embodiments may be a preset weight value coefficient equaling a value such as 0. In other embodiments, the first weight value may be set as another value to reduce an effect that abnormal image features have on the fusion feature.

In operation S2034, the weight coefficient of the image feature is determined in a second manner.

In some embodiments, in response to that a second error between an image feature and the median feature matrix does not meet the second condition (for example, the second error is less than or equal to the second threshold), the image feature is accurate and the weight coefficient of the image feature may be determined based on the second error in the second manner. Expressions of the second manner may be:

$$\begin{matrix}{b}_{h} = {θ}_{h} / {\sum }_{h = 1}^{N} {θ}_{h} ; and & ( 11 ) \\ {θ}_{h} = 1 / {e}_{h} . & ( 12 )\end{matrix}$$

In the two expressions, bₕ is the weight coefficient of the h-image that is determined in the second manner, eₕ is the second error between the image feature of the h-th image and the median feature matrix, h is an integer between 1 and N and N represents the number of the images.

In response to that a second error corresponding to an image feature is less than or equal to the second threshold, a weight coefficient bₕ of the image feature may be obtained in the second manner.

Based on the embodiment of the disclosure, the weight coefficient of each image feature may be obtained in the median filtering manner. The median filtering manner further reduces computations in the determination of the weight coefficient of each image feature, effectively lowers the complexity of the computations and related processing, and increases the precision of the obtained fusion feature.

After the weight coefficient of each image feature is obtained, the feature fusion processing may be performed. For example, the fusion feature is obtained by summing products of the image features and corresponding weight coefficients.

In some embodiments of the disclosure, after the fusion feature is obtained, the fusion feature may be adopted to recognize a target object in the image. For example, the target object may be compared with images of each of objects that are stored in a database based on the fusion feature; if a degree of similarity between the target object and a first image in the database is greater than a similarity degree threshold, the target object may be determined as an object corresponding to the first image; thus it is possible to implement identity recognition and target recognition. In other embodiments of the disclosure, recognition may also be performed on objects of other types. The disclosure is not limited thereto.

A description of an example based on face images is given below in order to make the embodiment of the disclosure clearer.

In some embodiments, different face images for an object A such as N face images may be obtained first, where N is an integer greater than 1. After the N face images are obtained, a neural network that is capable of extracting face features may be adopted to extract face features from the N face images to form a face feature of each image Xᵢ=[xᵢ₁, xᵢ₂, xᵢ₃, . . . , x_{iD}] (an image feature).

After the face feature of each face image is obtained, a weight coefficient corresponding to the face feature may be determined. In some embodiments, the weight coefficient may be obtained in the feature fitting manner or the median filtering manner. Which manner to adopt depends on the received selection information. In response to that the feature fitting manner is adopted, a face feature matrix

$$X = [ {X}_{1} , {X}_{2} , … , {X}_{N} ] = \{ \begin{matrix}{x}_{11} & {x}_{12} & … & {x}_{1 D} \\ {x}_{21} & {x}_{22} & … & {x}_{2 D} \\ . & . & . & . \\ {x}_{N 1} & {x}_{N 2} & … & {x}_{N D}\end{matrix} \}$$

corresponding to each face feature may be obtained first, and then the feature fitting is performed on the image features to obtain a first weight matrix. The first weight matrix may be expressed as b=(X^{T}X+λI)⁻¹X^{T}Y. After that, the first optimizing processing may be performed on the first weight matrix. The iterative function for the first optimizing processing may be expressed as b^{(t)}=(X^{T}W^{(t-1)}X+λI)⁻¹X^{T}W^{(t-1)}Y. After the optimized first weight matrix is obtained, the weight coefficient of each face feature is determined based on parameters in the optimized first weight matrix.

In response to that the median filtering manner is adopted to obtain the weight coefficients, the image feature matrix may be also obtained. In this case, an element median of element values at a same position for each image feature in the image feature matrix is obtained; a median feature matrix M=[m₁, m₂, . . . , m_{D}] is determined according to the obtained element medians; the weight coefficient of each image feature is determined according to the second error between the image feature and the median feature matrix.

After the weight coefficient of each image feature is obtained, the fusion feature may be obtained by summing products of the image features and corresponding weight coefficients. The fusion feature may be further adopted to perform operations such as target detection, target recognition. The exemplary description of the fusion of the features in some embodiments is given above and does not serve as a detailed limitation on the embodiment of the disclosure.

According to the above description, different features of a same object may be fused in some embodiments. By determining the weight coefficient corresponding to each of the image features of different images of a same object according to the image features and adopting the weight coefficients of the image features to perform the feature fusion on the image features, it is possible to increase the precision of the feature fusion.

Those skilled in the art may understand that in the above methods in the detailed descriptions, an order in which all operations are written does not mean a strict order in which they are performed and do not bring any limitation on their implementation processes. The order in which the operations are performed should be determined by their functions and possible internal logics.

It can be understood that all above the method embodiments of the disclosure may combine with each other to form a combined embodiment without departing from the principles and the logics. Due to a limited space, the details will not be given in the disclosure.

In addition, an image processing device, an electronic device, a computer-readable storage medium, a program, all of which may be used to implement any of the image processing methods provided in the disclosure, are also provided in the disclosure. The descriptions of their corresponding methods should be referred to for their corresponding technical solutions and descriptions. Details will not be repeated herein.

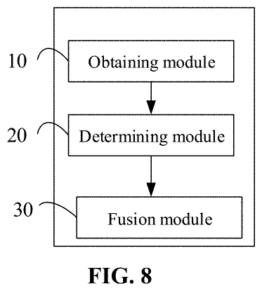

FIG. 8 is a block diagram of an image processing device according to an embodiment of the disclosure. The image processing device of the embodiment of the disclosure that is illustrated in FIG. 8 may include an obtaining module 10, a determining module 20 and a fusion module 30.

The obtaining module 10 is configured to: obtain an image feature of each of multiple images for a same object.

The determining module 20 is configured to: determine, according to the image feature of each of the multiple images, a weight coefficient having a one-to-one correspondence with each image feature.

The fusion module 30 is configured to: perform feature fusion processing on the image features of the multiple images based on the weight coefficient of each image feature to obtain a fusion feature of the multiple images.

In some embodiments, the determining module 20 includes a first establishing unit, a fitting unit and a first determining unit.

The first establishing unit is configured to: form an image feature matrix based on the image feature of each of the multiple images.

The fitting unit is configured to: perform feature fitting processing on the image feature matrix to obtain a first weight matrix.

The first determining unit is configured to: determine the weight coefficient corresponding to each image feature based on the first weight matrix.

In some embodiments, the fitting unit is further configured to: perform the feature fitting processing on the image feature matrix using a regularized least-square linear regression algorithm, and obtain the first weight matrix under condition that a preset target function takes a minimum value.

In some embodiments, the determining module 20 further includes an optimizing unit that is configured to perform first optimizing processing on the first weight matrix.

The first determining unit is further configured to: determine each of first weight coefficients included in the first weight matrix as the weight coefficient corresponding to each image feature or determine each of first weight coefficients included in an optimized first weight matrix as the weight coefficient corresponding to each image feature.

In some embodiments, the optimizing unit is further configured to: determine a fitting image feature of each of the multiple images based on the first weight coefficient of each of the image features included in the first weight matrix; perform the first optimizing processing on the first weight matrix using a first error between the image feature of each of the multiple images and the fitting image feature of the image to obtain a first optimized weight matrix; in response to that a difference between the first weight matrix and the first optimized weight matrix meets a first condition, determine the first optimized weight matrix as the optimized first weight matrix, and in response to that the difference between the first weight matrix and the first optimized weight matrix does not meet the first condition, obtain new fitting image features using the first optimized weight matrix, repeat the first optimizing processing based on the new fitting image features until a difference between a k-th optimized weight matrix and a (k−1)th optimized weight matrix meets the first condition and determine the k-th optimized weight matrix as the optimized first weight matrix. k is a positive integer greater than 1 and the fitting image feature is a product of the image feature and the first weight coefficient corresponding to the image feature.

In some embodiments, the optimizing unit is further configured to: obtain the first error between the image feature and the fitting image feature according to a sum of squares of differences between elements in the image feature and corresponding elements in the fitting image feature; obtain a second weight coefficient of each image feature based on each first error; and perform the first optimizing processing on the first weight matrix based on the second weight coefficient of each of the multiple images to obtain the first optimized weight matrix corresponding to the first weight matrix.

In some embodiments, the optimizing unit is further configured to: obtain the second weight coefficient of each image feature in a first manner based on each first error, herein an expression of the first manner is:

$${w}_{i} = \{ \begin{matrix}1 , {e}_{i} \leq k \\ \frac{k}{\vert {e}_{i} \vert} , {e}_{i} > k\end{matrix} .$$

Herein, wᵢ is the second weight coefficient of an i-th image, eᵢ represents a first error between an i-th image feature and a fitting image feature corresponding to the i-th image feature, i is an integer between i and N, N is a number of the image features, k=1.345 σ, σ is a standard deviation of the errors eᵢ.

In some embodiments, the determining module 20 further includes a second establishing unit, a filtering unit and a second determining unit.

The second establishing unit is configured to: form the image feature matrix based on the image feature of each of the multiple images.

The filtering unit is configured to: perform median filtering processing on the image feature matrix to obtain a median feature matrix.

The second determining unit is configured to: determine the weight coefficient corresponding to each image feature based on the median feature matrix.

In some embodiments, the filtering unit is further configured to: determine an element median of element values at a same position for each image feature in the image feature matrix; and obtain the median feature matrix based on the element median at each position.

In some embodiments, the second determining unit is further configured to:

obtain a second error between each image feature and the median feature matrix; and in response to that a second error between an image feature and the median feature matrix meets a second condition, configure a weight coefficient of the image feature to be a first weight value, and in response to that a second error between an image feature and the median feature matrix does not meet the second condition, determine a weight coefficient of the image feature in a second manner.

In some embodiments, expressions of the second manner are:

$${b}_{h} = {θ}_{h} / {\sum }_{h = 1}^{N} {θ}_{h} , and$$

$${θ}_{h} = 1 / {e}_{h} .$$

In the two expressions, bₕ is a weight coefficient of an h-image that is determined in the second manner, eₕ is a second error between an image feature of the h-th image and the median feature matrix, h is an integer between 1 and N and N represents the number of the multiple images.

In some embodiments, the second condition is:

eₕ>K·MADN, and

MADN=median([e₁, e₂, . . . , e_{N}])/0.675.

Herein, eₕ is the second error between the image feature of the h-th image and the median feature matrix, h is an integer between 1 and N, and N represents the number of the multiple images, K is a determination threshold and median represents a median filtering function.

In some embodiments, the fusion module 30 is further configured to: obtain the fusion feature by summing products of the image features and corresponding weight coefficients.

In some embodiments, the device further includes a recognizing module configured to perform a recognition operation on the same object using the fusion feature.

In some embodiments, the device further includes a mode determination model configured to obtain selection information for a mode for obtaining the weight coefficients, and determine, based on the selection information, the mode for obtaining the weight coefficients. The mode for obtaining the weight coefficients includes obtaining the weight coefficients in a feature fitting manner and obtaining the weight coefficients in a median filtering manner.

The determining module 20 is further configured to perform, based on the determined mode for obtaining the weight coefficients, the determination of the weight coefficient corresponding to the image feature of each of the multiple images according to the image feature.

Functions or modules that are included in the device provided in some embodiments of the disclosure may be used for performing the method described in the above method embodiments. The descriptions of the above method embodiments may be referred to for the detailed implementation of device, which are not elaborated herein for the sake of brevity.

A computer-readable storage medium is also provided in an embodiment of the disclosure. Computer program instructions are stored in the computer-readable storage medium and implement the above method when executed by a processor. The computer-readable storage medium may be a non-volatile computer-readable storage medium.

An electronic device is also provided in an embodiment of the disclosure. The electronic device includes a processer and a memory used for storing instructions executable by the processor. The processor is configured to perform the above method.

The electronic device may be provided as a terminal, a server or devices in other forms.

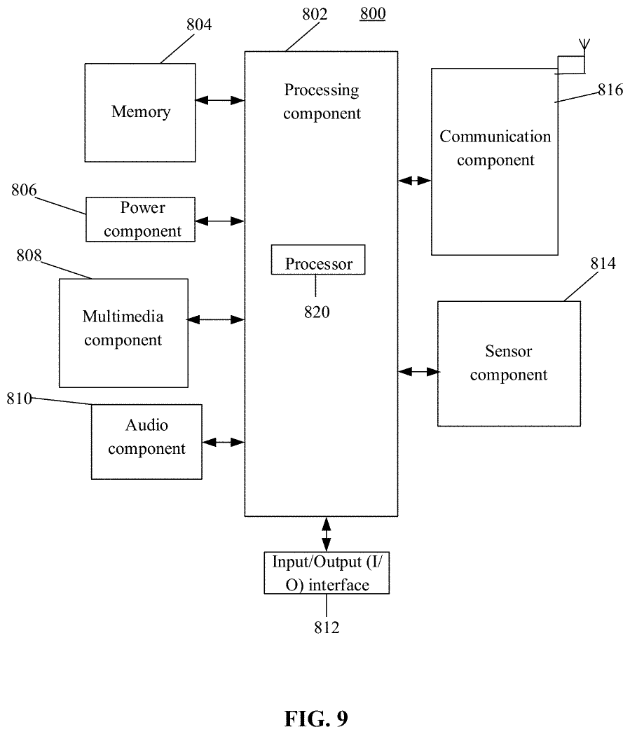

FIG. 9 is a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment and a PDA.

As illustrated in FIG. 9, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application program or method operated on the electronic device 800, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), an Read-Only Memory (ROM), a magnetic memory, a flash memory, a magnetic or optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focusing and optical zooming capability.

The audio component 810 is configured to output and/or input audio signals. For example, the audio component 810 includes a Microphone (MIC), and the MIC is configured to receive an external audio signal when the electronic device 800 is in an operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to perform the above described methods.

A non-volatile computer-readable storage medium such as the memory 804 including computer program instructions is also provided in an exemplary embodiment of the disclosure. The processor 820 of the electronic device 800 may execute the computer program instructions to perform the method.

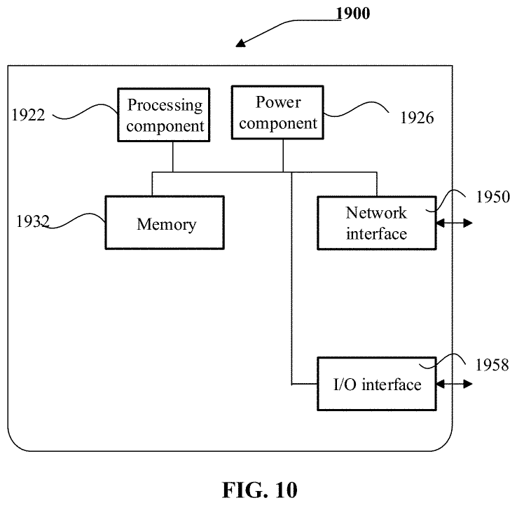

FIG. 10 is a block diagram of an electronic device 1900 according to an exemplary embodiment of the disclosure. For example, the electronic device 1900 may be provided as a server. As illustrated in FIG. 10, the electronic device 1900 includes a processing component 1922, which further includes one or more processors, and a memory resource which is represented by a memory 1932 and used for storing instructions (such as application programs) executable by the processing component 1922. The application programs stored in the memory 1932 may include one or more modules, each of which corresponds to a group of instructions. Moreover, the processing component 1922 is configured to execute the instructions to perform the above methods.

The electronic device 1900 may further include a power component 1926 configured to conduct power management of the electronic device 1900, a wired or wireless network interface 1950 configured to connect the electronic device 1900 to a network, and an Input/Output (I/O) interface 1958. The electronic device 1900 may operate based on an operation system stored in the memory 1932, such as Windows Server™, Mac OS X™, Unix™, Linux™, FreeBSD™ and the like.

In an exemplary embodiment, there is also provided a non-transitory computer-readable storage medium such as the memory 1932 including computer program instructions, and the computer program instructions may be executed by the processing component 1922 of the electronic device 1900 to implement the above methods.

The embodiment of the disclosure may be a system, a method and/or a computer program product. The computer program product may include the computer-readable storage medium which is loaded with the computer-readable program instructions used for enabling a processor to implement each aspect of the embodiments of the disclosure.

The computer-readable storage medium may be a tangible device that can keep and store instructions used by an instruction-executing device. The computer-readable storage medium may be but is not limited to, for example, an electric storage device, a magnetic storage device, an optical storage device, an electromagnetic storage device, a semiconductor storage device or any suitable combination of the aforementioned devices. More specific examples (an non-exhaustive list) of the computer-readable storage medium include: a portable computer disk, a hard disk, a Random Access Memory (RAM), a Read-Only Memory (ROM), an EPROM (or a flash memory), a Static Random Access Memory (SRAM), a Compact Disc Read-Only Memory (CD-ROM), a Digital Video Disk (DVD), a memory stick, a floppy disk, a mechanical encoding device, a punched card where instructions are stored or a protruding structure in a groove or any suitable combination thereof. The computer-readable storage medium used herein is not described as an instant signal such as a radio wave, other electromagnetic waves propagating freely, an electromagnetic wave propagating through a wave guide or other transmission media such as an optical pulse passing through a fiber-optic cable or an electric signal transmitting through electric wires.

The computer-readable program instructions described herein may be downloaded onto each computing or processing device from the computer-readable storage medium or onto an external computer or an external storage device through a network such as the Internet, a Local Area Network (LAN), a Wide Area Network (WAN) and/or a wireless network. The network may include a copper-transmitted cable, fiber-optic transmission, wireless transmission, a router, a firewall, a switch, a gateway computer and/or an edge server. A network adapter card or a network interface in each computing/processing device receives the computer-readable program instructions from the network and relays the computer-readable program instructions so that the computer-readable program instructions are stored in the computer-readable storage medium in each computing/processing device.

The computer program instructions used for performing the operations of the disclosure may be assembly instructions, Instruction Set Architecture (ISA) instructions, machine instructions, machine-related instructions, micro-codes, firmware instructions, state-setting data, source codes or target codes that are written in one programming language or any combination of several programming languages. The programming languages include object-oriented languages such as Smalltalk, C++, conventional procedure-oriented languages such as a “C” language or similar programming languages. The computer-readable program instructions can be completely or partially executed on a user computer, or executed as a separate software package. The computer-readable program instructions may also be partially executed on the user computer with the remaining executed on the remote computer, or completely executed on the remote computer or a server. In the case of the remote computer, the remote computer may connect to the user computer through any kind of network that includes the LAN and the WAN, or may connect to the external computer (for example, the remote computer may make the connection through the Internet with the help of an Internet service provider). In some embodiments, state information of the computer-readable program instructions is adopted to personalize an electric circuit such as a programmable logic circuit, a Field Programmable Gate Array (FPGA) and a Programmable Logic Array (PLA). The electric circuit may execute the computer-readable program instructions to implement each aspect of the disclosure.

Each aspect of the disclosure is described herein with reference to the flowcharts and block diagrams of the method, the device (the system) and the computer program product according to the embodiments of the disclosure. It should be understood that each block in the flowcharts and/or the block diagrams and combinations of each block in the flowcharts and/or the block diagrams may be implemented by the computer-readable program instructions.

The computer-readable program instructions may be provided to the processor of a general-purpose computer, a specific-purpose computer or another programmable data-processing device to produce a machine so that these instructions produce a device that implements functions/actions specified in one or more blocks in the flowcharts and/or the block diagrams, when executed through the processor of the computer or another programmable data-processing device. The computer-readable program instructions may also be stored in the computer-readable storage medium to make the computer, the programmable data-processing device and/or other devices to work in a specific manner. In this case, the computer-readable medium where the instructions are stored include a manufactured product that includes the instructions for implementing each aspect of the functions/the actions specified in one or more blocks in the flowcharts and/or the block diagrams.

The computer-readable program instructions may also be loaded on the computer, other programmable data-processing devices or other devices to make a series of operations performed on the computer, other programmable data-processing devices or other devices and establish procedures implemented by the computer so that the instructions executed in the computer, other programmable data-processing devices, or other devices implement the functions/the actions in one or more blocks of flowcharts and/or the block diagrams.

The flowcharts and the block diagrams in the accompanying drawings illustrate systems, architectures, functions and operations that are possibly implemented by the system, method and the computer program product according to the multiple embodiments of the disclosure. At this point, each block in the flowcharts or the block diagrams may represent a module, a program segment or a part of the instructions. The module, the program segment or the part of the instructions include one or more executable instructions used for implementing specified logical functions. In some implementations that serve as substitutes, the annotated functions in the block may also happen in an order different from the annotated order in the accompanying drawings. For example, depending on the relevant functions, two adjacent blocks actually may be basically executed in parallel or sometimes in opposite orders. It should also be noted that each block or a combination of the blocks in the block diagrams and/or the flowcharts may be implemented by a specific hardware-based system for performing specified functions or actions or be implemented by a combination of specific hardware and computer instructions.

Each embodiment of the disclosure has been described above. The above descriptions are not exhaustive but exemplary and are also not limited to each of the disclosed embodiments. Many changes and modifications are apparent to those of ordinary skills in the art without departing from the scope and the spirit of each of the described embodiments. The terminology used herein is chosen to best explain the principles, the practical applications or the improvement of the technologies in the market mentioned in each embodiment or enable others of ordinary skills in the art to understand each embodiment disclosed herein.

1. An image processing method, comprising:
obtaining an image feature of each of a plurality of images for a same object;
determining, according to the image feature of each of the plurality of images, a weight coefficient having a one-to-one correspondence with each image feature; and
performing feature fusion processing on the image features of the plurality of images based on the weight coefficient of each image feature to obtain a fusion feature of the plurality of images.

2. The method of claim 1, wherein determining, according to the image feature of each of the plurality of images, the weight coefficient having the one-to-one correspondence with each image feature comprises:
forming an image feature matrix based on the image feature of each of the plurality of images;
performing feature fitting processing on the image feature matrix to obtain a first weight matrix; and
determining the weight coefficient corresponding to each image feature based on the first weight matrix.

3. The method of claim 2, wherein performing the feature fitting processing on the image feature matrix to obtain the first weight matrix comprises:
performing the feature fitting processing on the image feature matrix using a regularized least-square linear regression algorithm, and obtaining the first weight matrix under condition that a preset target function takes a minimum value.

4. The method of claim 2, wherein determining the weight coefficient corresponding to each image feature based on the first weight matrix comprises:
determining each of first weight coefficients comprised in the first weight matrix as the weight coefficient corresponding to each image feature; or performing first optimizing processing on the first weight matrix, and
determining each of first weight coefficients comprised in an optimized first weight matrix as the weight coefficient corresponding to each image feature.

5. The method of claim 4, wherein performing the first optimizing processing on the first weight matrix comprises:
determining a fitting image feature of each of the plurality of images based on the first weight coefficient of each of the image features comprised in the first weight matrix, wherein the fitting image feature is a product of the image feature and the first weight coefficient corresponding to the image feature,
performing the first optimizing processing on the first weight matrix using a first error between the image feature of each of the plurality of images and the fitting image feature of the image to obtain a first optimized weight matrix;
in response to that a difference between the first weight matrix and the first optimized weight matrix meets a first condition, determining the first optimized weight matrix as the optimized first weight matrix, or in response to that the difference between the first weight matrix and the first optimized weight matrix does not meet the first condition, obtaining new fitting image features using the first optimized weight matrix, repeating the first optimizing processing based on the new fitting image features until a difference between a k-th optimized weight matrix and a (k−1)th optimized weight matrix meets the first condition and determining the k-th optimized weight matrix as the optimized first weight matrix, wherein k is a positive integer greater than 1.

6. The method of claim 5, wherein performing the first optimizing processing on the first weight matrix using the first error between the image feature of each of the plurality of images and the fitting image feature of the image comprises:
obtaining the first error between the image feature and the fitting image feature according to a sum of squares of differences between elements in the image feature and corresponding elements in the fitting image feature;
obtaining a second weight coefficient of each image feature based on each first error; and
performing the first optimizing processing on the first weight matrix based on the second weight coefficient of each of the plurality of images to obtain the first optimized weight matrix corresponding to the first weight matrix.

7. The method of claim 6, wherein obtaining the second weight coefficient of each image feature based on each first error comprises:
obtaining the second weight coefficient of each image feature in a first manner based on each first error, wherein an expression of the first manner is:
$${w}_{i} = \{ \begin{matrix}1 , {e}_{i} \leq k \\ \frac{k}{\vert {e}_{i} \vert} , {e}_{i} > k\end{matrix} ,$$
where is the second weight coefficient of an i-th image; eᵢ represents a first error between an i-th image feature and a fitting image feature corresponding to the i-th image feature, i is an integer between i and N, and N is a number of the image features; and k=1.345 σ, and σ is a standard deviation of the errors eᵢ.

8. The method of claim 1, wherein determining, according to the image feature of each of the plurality of images, the weight coefficient having the one-to-one correspondence with each image feature further comprises:
forming the image feature matrix based on the image feature of each of the plurality of images;
performing median filtering processing on the image feature matrix to obtain a median feature matrix; and
determining the weight coefficient corresponding to each image feature based on the median feature matrix.

9. The method of claim 8, wherein performing median filtering processing on the image feature matrix to obtain the median feature matrix comprises:
determining an element median of element values at a same position for each image feature in the image feature matrix; and
obtaining the median feature matrix based on the element median at each position.

10. The method of claim 8, wherein determining the weight coefficient corresponding to each image feature based on the median feature matrix comprises:
obtaining a second error between each image feature and the median feature matrix; and
in response to that a second error between an image feature and the median feature matrix meets a second condition, configuring the weight coefficient of the image feature to be a first weight value, or in response to that a second error between an image feature and the median feature matrix does not meet the second condition, determining the weight coefficient of the image feature in a second manner.

11. The method of claim 10, wherein expressions of the second manner are:
$${b}_{h} = {θ}_{h} / {\sum }_{h = 1}^{N} {θ}_{h} , and$$
$${θ}_{h} = 1 / {e}_{h} ,$$
where bₕ is a weight coefficient of an h-th image determined in the second manner; and eₕ is a second error between an image feature of the h-th image and the median feature matrix, h is an integer between 1 and N, and N represents a number of the plurality of images.

12. The method of claim 10, wherein the second condition is:
eₕ>K·MADN, and
MADN=median([e₁, e₂, . . . , e_{N}])/0.675.
where eₕ is the second error between the image feature of the h-th image and the median feature matrix, h is an integer between 1 and N, and N represents the number of the plurality of images; K is a determination threshold; and median represents a median filtering function.

13. The method of claim 1, wherein performing the feature fusion processing on the image features of the plurality of images based on the weight coefficient of each image feature to obtain the fusion feature of the plurality of images comprises:
obtaining the fusion feature by summing products of the image features and corresponding weight coefficients.

14. The method of claim 1, further comprising:
performing a recognition operation on the same object using the fusion feature.

15. The method of claim 1, further comprising: before determining the weight coefficient corresponding to the image feature of each of the plurality of images according to the image feature,
obtaining selection information for a mode for obtaining the weight coefficients;
determining, based on the selection information, the mode for obtaining the weight coefficients;
performing, based on the determined mode for obtaining the weight coefficients, the determination of the weight coefficient corresponding to the image feature of each of the plurality of images according to the image feature,
wherein the mode for obtaining the weight coefficients comprises obtaining the weight coefficients in a feature fitting manner and obtaining the weight coefficients in a median filtering manner.

16. An image processing device, comprising:
a memory storing processor-executable instructions; and
a processor configured to execute the stored processor-executable instructions to perform operations of:
obtaining an image feature of each of a plurality of images for a same object;
determining, according to the image feature of each of the plurality of images, a weight coefficient having a one-to-one correspondence with each image feature; and
performing feature fusion processing on the image features of the plurality of images based on the weight coefficient of each image feature to obtain a fusion feature of the plurality of images.

17. The device of claim 16, wherein determining, according to the image feature of each of the plurality of images, the weight coefficient having the one-to-one correspondence with each image feature comprises:
forming an image feature matrix based on the image feature of each of the plurality of images;
performing feature fitting processing on the image feature matrix to obtain a first weight matrix; and
determining the weight coefficient corresponding to each image feature based on the first weight matrix.

18. The device of claim 17, wherein performing the feature fitting processing on the image feature matrix to obtain the first weight matrix comprises:
performing the feature fitting processing on the image feature matrix using a regularized least-square linear regression algorithm, and obtaining the first weight matrix under condition that a preset target function takes a minimum value.

19. The device of claim 17, wherein determining the weight coefficient corresponding to each image feature based on the first weight matrix comprises:
determining each of first weight coefficients comprised in the first weight matrix as the weight coefficient corresponding to each image feature; or
performing first optimizing processing on the first weight matrix, and determining each of first weight coefficients comprised in an optimized first weight matrix as the weight coefficient corresponding to each image feature.

20. A non-transitory computer-readable storage medium having stored thereon computer-readable instructions that, when executed by a processor, cause the processor to perform an image processing method, the method comprising:
obtaining an image feature of each of a plurality of images for a same object;
determining, according to the image feature of each of the plurality of images, a weight coefficient having a one-to-one correspondence with each image feature; and
performing feature fusion processing on the image features of the plurality of images based on the weight coefficient of each image feature to obtain a fusion feature of the plurality of images.
